(19) United States
(12) Patent Application Publication
(10) Pub. No.: US 2022/0067376 A1
(43) Pub. Date: Mar. 3, 2022

(54) METHOD FOR GENERATING HIGHLIGHT IMAGE USING BIOMETRIC DATA AND DEVICE THEREFOR

(71) Applicant: LOOXID LABS INC., Daejeon (KR)

(72) Inventor: Hong Gu LEE, Seoul (KR)

(21) Appl. No.: 17/420,138

(22) PCT Filed: Jan. 7, 2020
(86) PCT No.: PCT/KR2020/000255

§ 371 Date: Jun. 30, 2021

(30) Foreign Application Priority Data
Jan. 28, 2019 (KR) 10-2019-0010448

(51) Int. Cl. G06K 9/00; G06F 3/01

(52) U.S. Cl. CPC G06K 9/00671; G06F 3/013; G06F 3/015; G06K 9/00026

(57) ABSTRACT

Provided are a method and a device for generating a highlight image using biometric data according to the embodiment of the present invention. The embodiment of the present invention provides a method of generating a highlight image using biometric data of a user executed by a processor of a device for generating a highlight image according to the embodiment of the present invention, the method including: providing multimedia content through a head-mounted display (HMD) device configured to acquire biometric data including at least one of user's brainwave and gaze data; acquiring biometric data associated with the multimedia content through the HMD device; detecting at least one partial content noticed by the user on the basis of the acquired biometric data; predicting an emotional state of the user associated with the detected at least one partial content; and generating a highlight image according to the predicted emotional state.

### Technical Field

The present invention provides a method and a device for generating a highlight image using biometric data.

### BACKGROUND ART

Recently, with the development of information communication technologies and network technologies, devices are evolved to multimedia mobile devices having various functions. In recent years, the device has sensors capable of detecting a user's biological signals and signals generated at the periphery of the device.

Among the devices, a head-mounted display (HMD) device (hereinafter, referred to as an ‘HMD device’) refers to a display device having a structure that may be worn on the user's head and configured to providing images in relation to virtual reality (VR), augmented reality (AR), and/or mixed reality (MR) to the user to enable the user to have a spatial, temporal experience similar to the actual experience. The HMD device includes a main body provided in the form of goggles so as to be worn on the user's eye area, and a wearing part connected to the main body and provided in the form of a band in order to fix the main body to the user's head. In this case, the main body has a display as a means for outputting a virtual reality image, a portable terminal device such as a smartphone, or a display device such as a monitor connected to a PC or the like. Using the HMD device, the user may watch and experience various types of multimedia content, and the HMD device or an electronic device connected to the HMD device may provide highlight images associated with the multimedia content that the user has watched and experienced. In general, the HMD device or the electronic device analyzes the multimedia content, edits scenes predicted as interesting to the user in the multimedia content as highlight images, and provides the highlight images to the user.

However, since the highlight images provided as described above merely include the scenes predicted as interesting to the user in the multimedia content, the highlight images may differ from the scenes in which the user actually feels interested.

Accordingly, there is a need for a method of generating a highlight image made by editing scenes in which the user actually feels interested.

### SUMMARY OF THE DISCLOSURE

An object of the present invention is to provide a method and a device for generating a highlight image using biometric data.

Specifically, another object of the present invention is to provide a method and a device for generating a user-customized highlight image using biometric data.

Technical problems of the present invention are not limited to the aforementioned technical problems, and other technical problems, which are not mentioned above, may be clearly understood by those skilled in the art from the following descriptions.

In order to achieve the above-mentioned objects, the present invention provides a method and a device for generating a highlight image using biometric data. An embodiment of the present invention provides a method of generating a highlight image using biometric data of a user executed by a processor of a device for generating a highlight image according to the embodiment of the present invention, the method including: providing multimedia content through a head-mounted display (HMD) device configured to acquire biometric data including at least one of user's brainwave and gaze data; acquiring biometric data associated with the multimedia content through the HMD device; detecting at least one partial content noticed by the user on the basis of the acquired biometric data; predicting an emotional state of the user associated with the detected at least one partial content; and generating a highlight image according to the predicted emotional state.

Another embodiment of the present invention provides a device for generating a highlight image using biometric data, the device including: a communication unit; a storage unit; and a processor operably connected to the communication unit and the storage unit, in which the processor provides multimedia content through a head-mounted display (HMD) device configured to acquire biometric data including at least one of a user's brainwave and gaze data, acquires biometric data associated with the multimedia content through the HMD device, detects at least one partial content noticed by the user on the basis of the acquired biometric data, predicts an emotional state of the user associated with the detected at least one partial content, and generates a highlight image according to the predicted emotional state.

Other detailed matters of the exemplary embodiment are included in the detailed description and the drawings.

The present invention may provide the user-customized highlight image by generating the highlight image associated with the multimedia content using the biometric data of the user acquired while the user watches or experiences the multimedia content.

In addition, the present invention may provide the highlight image focusing on the object noticed by the user, thereby improving the user's satisfaction.

The effects according to the present invention are not limited to the above-mentioned effects, and more various effects are included in the present invention.

### BRIEF DESCRIPTION OF THE DRAWINGS

FIG. 1 is a schematic view for explaining a highlight image generation system using biometric data according to an embodiment of the present invention.

FIG. 2 is a schematic view for explaining an HMD device according to the embodiment of the present invention.

FIG. 3 is a schematic view for explaining an electronic device according to the embodiment of the present invention.

FIG. 4 is a schematic flowchart for explaining a method of generating a highlight image associated with multimedia content on the basis of biometric data of a user by the electronic device according to the embodiment of the present invention.

FIGS. 5A, 5B, 5C, and 5D are exemplified views for explaining methods of generating highlight images associated with multimedia content on the basis of biometric data of the user by the electronic device according to the embodiment of the present invention.

### DETAILED DESCRIPTION OF THE DISCLOSURE

Advantages and features of the present invention and methods of achieving the advantages and features will be clear with reference to exemplary embodiments described in detail below together with the accompanying drawings. However, the present invention is not limited to the exemplary embodiments disclosed herein but will be implemented in various forms. The exemplary embodiments of the present invention are provided so that the present invention is completely disclosed, and a person with ordinary skill in the art to which the present invention pertains may fully understand the scope of the present invention. the present invention will be defined only by the scope of the appended claims.

Terms “first”, “second”, and the like may be used to describe various constituent elements, but the constituent elements are of course not limited by these terms. These terms are merely used to distinguish one constituent element from another constituent element. Therefore, the first constituent element mentioned hereinafter may of course be the second constituent element within the technical spirit of the present invention.

Throughout the specification, the same reference numerals denote the same constituent elements.

Respective features of several exemplary embodiments of the present invention may be partially or entirely coupled to or combined with each other, and as sufficiently appreciated by those skilled in the art, various technical cooperation and operations may be made, and the respective exemplary embodiments may be carried out independently of each other or carried out together correlatively.

In the present invention, a highlight image providing system may include, so that limitation, all devices configured to acquire a user's gaze and acquire biometric data such as the user's brainwave. For example, the highlight providing system may include; a device including a sensor, such as a headset, a smart ring, a smart watch, an ear set, or an earphone in addition to a head-mounted display (HMD), configured to be in contact with/worn on a part of the user's body and acquire the biometric data of the user; a content output device configured to output multimedia content associated with virtual reality, augmented reality, and/or mixed reality; and an electronic device configured to manage the device and the content output device. For example, in a case in which the HMD device has a display unit, the highlight providing system may include only the HMD device and the electronic device. In this case, the biometric data may indicate various signals, such as the user's pulse, blood pressure, and brainwave, generated from the user's body in accordance with the user's conscious and/or unconscious behavior (e.g., breathing, heartbeat, metabolism, and the like).

Hereinafter, various embodiments of the present invention will be described in detail with reference to the accompanying drawings.

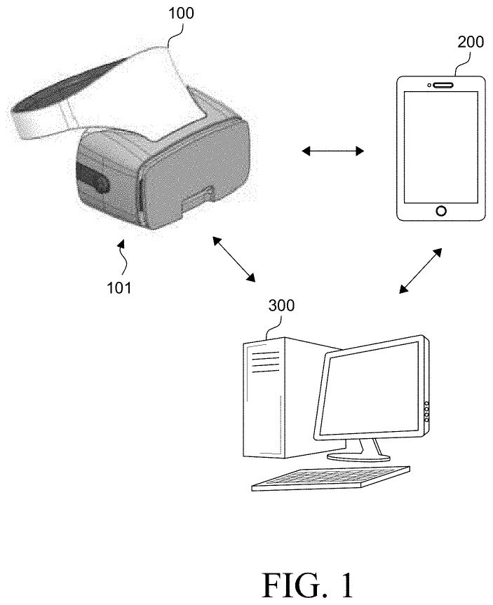

FIG. 1 is a schematic view for explaining a highlight image generation system using biometric data according to an embodiment of the present invention.

Referring to FIG. 1, a highlight image generation system 1000 refers to a system for generating a highlight image using biometric data including at least one of the user's brainwave and gaze data and may include an HMD device 100 configured to acquire the biometric data of the user, a content output device 200 configured to output multimedia content, and an electronic device 300 configured to generate a highlight image associated with the multimedia content. In various embodiments, in a case in which the HMD device 100 has a display unit, the content output device 200 may not be included in the highlight image generation system 1000.

The HMD device 100 may be a composite virtual experience device mounted on the user's head and configured to provide the multimedia content for virtual reality to the user to enable the user to have a spatial, temporal experience similar to the actual experience. The HMD device 100 may also detect physical, cognitive, and emotional changes of the user having the virtual experience by acquiring the biometric data of the user. For example, the multimedia content may include, but not limited to, non-interactive images, such as movies, animations, advertisements, or promotional image, and interactive images, such as games, electronic manuals, electronic encyclopedias, or promotional images that interact with the user. In this case, the image may be a three-dimensional image and may include a stereoscopic image.

The HMD device 100 has a structure that may be worn on the user's head. The HMD device 100 may be implemented such that various types of multimedia content for virtual reality is processed in the HMD device 100. Alternatively, the content output device 200 for providing the multimedia content may be mounted on a part of the HMD device 100, and the multimedia content may be processed in the mounted content output device 200.

In the case in which the HMD device 100 has the display unit, one surface of the display unit may be disposed to face the user's face so that the user may recognizes the multimedia content when the user wears the HMD device 100.

In various embodiments, a receiving space 101 capable of accommodating the content output device 200 may be provided in a part of the HMD device 100. In the case in which the content output device 200 is accommodated in the receiving space 101, the user's face may be directed toward one surface of the content output device 200 (e.g., one surface of the content output device 200 on which the display unit is positioned). For example, the content output device 200 may include a portable monitor or the like which is connected to a PC or a portable terminal device such as a smartphone or a tablet PC and may output the multimedia content provided from the PC.

One or more sensors (not illustrated) for acquiring the user's brainwave or gaze data may be provided at one side of the HMD device 100. The one or more sensors may include a brainwave sensor configured to measure the user's brainwave and/or a gaze tracking sensor configured to track the user's gaze. In various embodiments, the one or more sensors are disposed at position at which an image of the user's eye or face may be captured or a position at which the sensor may come into contact with the user's skin. When the user wears the HMD device 100, the sensor captures an image of the user's eye or face and acquires the user's gaze data by analyzing the captured image. Alternatively, the sensor comes into contact with the user's skin and may acquire the brainwave data such as electroencephalography (EEG), electromyography (EMG), or electrocardiogram (ECG) of the user. In the present specification, the HMD device 100 is described as including the one or more sensors for acquiring the user's brainwave and/or gaze data, but the present invention is not limited thereto, and one or more sensors for acquiring the user's brainwave and/or gaze data through a module separated from the HMD device 100 may be mounted on the HMD housing. The expression “HMD device 100” is intended to include the module or be the module itself.

In accordance with the request from the content output device 200 or the electronic device 300, the HMD device 100 may acquire the biometric data of the user and transmit the acquired biometric data to the content output device 200 or the electronic device 300.

In the case in which the HMD device 100 includes the display unit, the multimedia content is displayed on the display unit of the HMD device 100 in order to acquire the biometric data of the user, and the biometric data associated with the multimedia content may be acquired by the one or more sensors provided in the HMD device 100. The HMD device 100 may transmit the acquired biometric data to the electronic device 300.

In the case in which the content output device 200 is accommodated in the receiving space 101 of the HMD device 100, the HMD device 100 may acquire the biometric data associated with the multimedia content outputted through the content output device 200 and transmit the acquired biometric data to the electronic device 300.

The electronic device 300 refers to a device which is connected to the HMD device 100 and/or the content output device 200 so as to communicate with the HMD device 100 and/or the content output device 200, provides the multimedia content to the HMD device 100 or the content output device 200, and generates the highlight image associated with the multimedia content on the basis of the acquired biometric data through the HMD device 100. The electronic device 300 may include a PC (personal computer), a notebook computer, a workstation, a smart TV, or the like.

The electronic device 300 may extract biometric characteristic data from the biometric data acquired through the HMD device 100. For example, the electronic device 300 may extract brainwave characteristic data from the brainwave data or extract gaze characteristic data from the gaze data. The brainwave characteristic data may include band power in a specific frequency region of the brainwave or an energy ratio between an alpha wave and a beta wave of the brainwave. In addition, the gaze characteristic data may include a gaze period for which the user's gaze is performed, a gaze tracking period for which the user's gaze tracks a specific object of the multimedia content, or the number of eye blinking which is the number of times the user's eye blinks. The biometric data are not limited to the above-mentioned data and may include various biometric data.

In various embodiments, the electronic device 300 may extract the biometric characteristic data from the biometric data acquired through the HMD device 100 on the basis of a deep learning algorithm learned to extract the biometric characteristic data. For example, the electronic device 300 may extract various biometric characteristic data such as the brainwave characteristic data and the gaze characteristic data on the basis of the deep learning algorithm learned to extract the brainwave characteristic data from the brainwave data and learned to extract the gaze characteristic data from the gaze data. In this case, the deep learning algorithm may be at least one of DNN (deep neural network), CNN (convolutional neural network), DCNN (deep convolution neural network), RNN (recurrent neural network), RBM (restricted Boltzmann machine), DBN (deep belief network), and SSD (single shot detector). However, the deep learning algorithm is not limited to the above-mentioned deep learning algorithms, and the electronic device 300 may use more various algorithms capable of extracting the biometric characteristic data on the basis of the biometric data.

The electronic device 300 may detect at least one partial content noticed by the user on the basis of the biometric characteristic data and infer or determine an emotional state of the user associated with the detected at least one partial content. In this case, the partial content may include at least one scene data as at least a part of the multimedia content. For example, the scene data may mean respective frames constituting the multimedia content.

Specifically, the electronic device 300 may detect the at least one partial content associated with at least one of the corresponding brainwave and gaze characteristic data when at least one of the brainwave and gaze characteristic data satisfy a specific condition. In this case, the specific condition may include a case in which a value of the respective characteristic data is a corresponding critical value or more or less. The critical value of the respective characteristic data is determined in advance to detect the at least one partial content in accordance with the respective characteristic data, and the critical value may vary depending on the respective characteristic data. For example, when the band power in the specific frequency region of the brainwave or the energy ratio between the alpha wave and the beta wave of the brainwave is greater than or equal to the critical value, the electronic device 300 may detect the at least one partial content corresponding to the band power or the energy ratio as the partial content noticed by the user. When the gaze period or the gaze tracking period is greater than or equal to the critical value or the number of eye blinking is lower than or equal to the critical value, the electronic device 300 may detect the at least one partial content corresponding to the gaze period or the gaze tracking period as the partial content noticed by the user or detect the at least one partial content corresponding to the number of eye blinking as the partial content noticed by the user. In various embodiments, when the brainwave characteristic data satisfy the specific condition, the gaze characteristic data satisfy the specific condition, or both the brainwave characteristic data and the gaze characteristic data satisfy the specific condition, the electronic device 300 may detect the at least one partial content associated therewith.

In various embodiments, the electronic device 300 may perform the detection on the basis of the deep learning algorithm configured to detect the partial content highly associated with the emotion on the basis of the biometric characteristic data. For example, the electronic device 300 may determine the partial content having a high degree of notice to the user on the basis of the deep learning algorithm configured to extract the partial content noticed by the user on the basis of the band power in the specific frequency region of the brainwave of the brainwave characteristic data or the energy ratio between the alpha wave and the beta wave of the brainwave. As another example, the electronic device 300 may determine the partial content having a high degree of notice to the user on the basis of the deep learning algorithm configured to extract the partial content noticed by the user on the basis of the gaze period or the number of eye blinking as the gaze characteristic data. In this case, the deep learning algorithm may be at least one of DNN, CNN, DCNN, RNN, RBM, DBN, and SSD. However, the present invention is not limited thereto, and the electronic device 300 may use more various algorithms as long as the electronic device 300 may determine the partial content on the basis of the biometric characteristic data.

In various embodiments, the electronic device 300 may provide the multimedia content (e.g., games, videos, or the like) in order to check the biometric data in accordance with the user's recognition and/or concentration and detect, as the partial content noticed by the user, the at least one partial content associated with the biometric data similar or identical to the biometric data learned by learning the biometric data of the user acquired from the provided multimedia content. The electronic device 300 may group the detected at least one partial content and the biometric data associated with the at least one partial content into one or more groups. For example, the electronic device 300 may use a machine learning technique or the like and group the at least one partial content, at least one partial content having similar characteristics among the biometric data associated with the at least one partial content, and the biometric data associated therewith into one or more groups. The machine learning technique may include a k-means algorithm, a Gaussian mixture model (GMM), a random forest model, or the like, but the present invention is not limited thereto, and various grouping techniques may be used.

The electronic device 300 may extract the emotional state of the user for each group by analyzing the scenes of the at least one partial content belonging to each of the groups. In this case, the emotional state may mean pleasure, surprise, sadness, anger, fear, and disgust felt by the user which recognizes an object, a landscape, an atmosphere, a color, or music belonging to each of the scenes included in the at least one partial content. For example, in a case in which the scenes corresponding to the at least one partial content of the specific group are related to the acquisition of game items, the electronic device 300 may predict the emotional state of the user for the specific group as “pleasure”. The electronic device 300 may finally determine the emotional state of the user on the basis of a classification algorithm configured to classify the emotional state of the user on the basis of the partial content. For example, the classification algorithm may be at least one of random forest, GNB (Gaussian na_ive Bayes), LNB (locally weighted na_ive Bay), and SVM (support vector machine). However, the classification algorithm is not limited to the above-mentioned algorithm, and the electronic device 300 may use more various algorithms capable of extracting the user's emotion on the basis of the partial content. By using the classification algorithm, the electronic device 300 may recognize the object, the landscape, the atmosphere, the color, the music, or the like belonging to the scene by analyzing the scenes corresponding to the at least one partial content and predict the emotional state of the user corresponding to at least one of the recognized object, the landscape, the atmosphere, the color, and the music.

In various embodiments, the electronic device 300 may receive the user's input in respect to the at least one partial content for each of the groups in order to acquire the information on the emotional state of the user in respect to the at least one partial content for each of the groups. For example, the electronic device 300 may provide an interface screen for acquiring the user's input in respect to the at least one partial content for each of the groups through the HMD device 100 and may receive the input in respect to the emotional state of the user who recognizes and feels the at least one partial content for each of the groups through the interface screen. In this case, the interface screen may include a display space for displaying the partial content for each of the groups and an input space for inputting the emotional state such as user's pleasure, surprise, sadness, anger, fear, and disgust for each of the group, or the interface screen may include a graphic space for tagging tags associated with the emotional state for each of the group. When the information on the emotional state inputted through the interface screen in respect to the at least one partial content for the specific group is “pleasure”, the electronic device 300 may determine the emotional state of the user for the specific group as “pleasure”. In various embodiments, the electronic device 300 may group the biometric data and the at least one content associated with the biometric data, which are acquired after the emotional state of the user for each of the groups is predicted or determined, into a group including the biometric data similar or identical to the corresponding biometric data. In various embodiments, the electronic device 300 may predict the emotional state of the user based on various combinations. For example, when the detected music is sad music even though the expression of the detected face is a smiley expression, the electronic device 300 may predict the emotional state of the user as sadness.

The electronic device 300 may generate the highlight image using the at least one partial content for each of the groups corresponding to the predicted emotional state. Specifically, the electronic device 300 may arrange the at least one partial content belonging to each of the groups in an arrangement order and generate the highlight image by including or editing the arranged at least one partial content. In this case, the arrangement order includes the temporal order, the increasing order of the emotional state of the user, and the decreasing order of the user's notice and/or concentration, but the present invention is not limited thereto, and various orders may be included. For example, when at least one partial content detected from game image data is grouped into three groups, an emotional state in respect to at least one partial content corresponding to a first group is “pleasure”, an emotional state in respect to at least one partial content corresponding to a second group is “sadness”, and an emotional state in respect to at least one partial content corresponding to a third group is “fear”, the electronic device 300 may arrange the at least one partial content corresponding to the first group, the at least one partial content corresponding to the second group, and the at least one partial content corresponding to the third group in the temporal order, the increasing order of the emotional state of the user, or the decreasing order of the user's notice and/or concentration. The electronic device 300 may generate the highlight images on the basis of the at least one partial content for the first group, the second group, and the third group arranged as described above. In various embodiments, the electronic device 300 may generate the highlight image by combining the at least one partial content, editing the at least one partial content, or applying an effect to the at least one partial content.

In the provided embodiment, the configuration in which the electronic device 300 generates the highlight image associated with the multimedia content on the basis of the acquired biometric data through the HMD device 100 is described, but the present invention is not limited thereto. It is possible to generate the highlight image associated with the multimedia content on the basis of the acquired biometric data by the HMD device 100 performing the operation of the electronic device 300 without the electronic device 300.

Therefore, the present invention may provide the user-customized highlight image associated with the multimedia content.

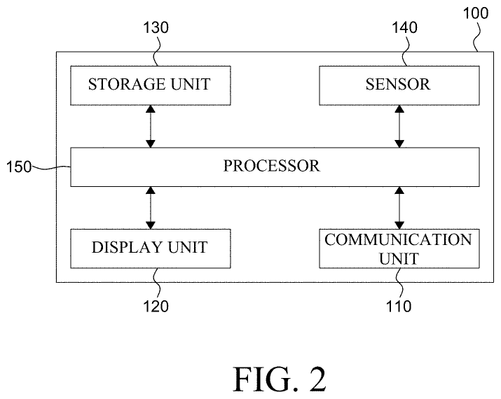

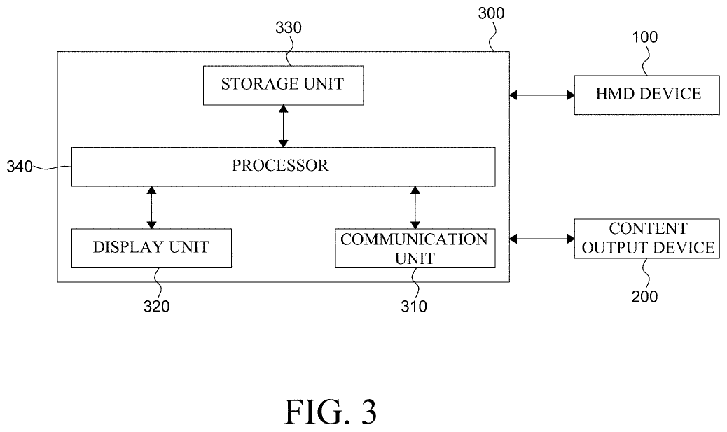

Hereinafter, the HMD device 100 and the electronic device 300 will be described in more detail with reference to FIGS. 2 and 3.

FIG. 2 is a schematic view for explaining the HMD device according to the embodiment of the present invention. In the provided embodiment, the HMD device 100 including the display unit will be described. Referring to FIGS. 1 and 2, the HMD device 100 includes a communication unit 110, a display unit 120, a storage unit 130, a sensor 140, and a processor 150.

The communication unit 110 connects the HMD device 100 to an external device so that the HMD device 100 may communicate with the external device. The communication unit 110 is connected to the electronic device 300 through wired/wireless communication and may transmit and receive various pieces of information. In this case, the wired communication may include at least one of USB (universal serial bus), HDMI (high-definition multimedia interface), RS-232 (recommended standard 232), power line communication, and POTS (plain old telephone service). The wireless communication may include at least one of WiFi (wireless fidelity), Bluetooth, Bluetooth low energy (BLE), Zigbee, NFC (near field communication), magnetic secure transmission, radio frequency (RF), and body area network (BAN). Specifically, the communication unit 110 may receive the multimedia content from the electronic device 300 and transmit the biometric data, acquired by the sensor 140, to the electronic device 300.

The display unit 120 may display various types of contents (e.g., texts, images, videos, icons, banners, or symbols, etc.) to a user. Specifically, the display unit 120 may display the multimedia content received from the electronic device 300. In various embodiments, the display unit 120 may display an interface screen for inputting or tagging the information on the emotional state of the user associated with the at least one partial content grouped on the basis of the biometric data of the user.

The storage unit 130 may store various data used to generate the highlight image associated with the multimedia content on the basis of the biometric data of the user. Specifically, the storage unit 130 may store the biometric data of the user acquired by the sensor 140. The storage unit 130 may store the multimedia content received from the electronic device.

In various embodiments, the storage unit 130 may include at least one storage medium among a flash type memory, a hard disc type memory, a multimedia card micro type memory, a card-type memory (e.g., an SD or XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disc, and an optical disc. The HMD device 100 may operate in connection with a web storage that performs a storage function of the storage unit 130 on the Internet.

The sensors 140 include one or more sensors used to acquire the biometric data of the user. For example, the sensors may include a gaze tracking sensor for tracking the user's gaze and/or a brainwave measurement sensor for measuring the user's brainwave. For example, the gaze tracking sensor may include a camera sensor for capturing an image of the user's eye or face. The image captured by the camera sensor may be outputted as gaze data, or the captured image may be analyzed and then outputted as gaze data indicating a position coordinate of the user's gaze. In various embodiments, various methods may be used to track the user's gaze. In addition to the analysis of the image, it is possible to track the user's gaze using a method using a contact lens (a gaze tracking method using light reflected from a mirror-embedded contact lens or a magnetic field of a coil-embedded contact lens) or a method using attached sensor (a gaze tracking method using an electric field according to a motion of the eye detected by a sensor attached to a periphery of the eye). In addition, a brainwave measurement sensor may include at least one of an EEG (electroencephalogram) sensor, an MEG (magnetoencephalography) sensor, an NIRS (near-infrared spectrometer), and the like. The brainwave measurement sensor may measure electrical/optical frequencies that changes in accordance with the brainwave having various frequencies generated from the user's body part being in contact with the brainwave measurement sensor or changes in accordance with an activation state of the brain, and the brainwave measurement sensor may output the electrical/optical frequencies as the brainwave data.

The processor 150 is operably connected to the communication unit 110, the display unit 120, the storage unit 130, and the sensor 140 and displays, on the display unit 120, the multimedia content received from the electronic device 300 through the communication unit 110. The processor 150 may transmit the biometric data of the user, acquired by the sensor 140, to the electronic device 300 while displaying the multimedia content. In the provided embodiment, the HMD device 100 having the display unit has been described. However, in a case in which the content output device 200 is mounted in the HMD device 100 without the display unit, the processor 150 may transmit the biometric data of the user, acquired by the sensor 140, to the electronic device 300 while the display unit of the content output device 200 displays the multimedia content.

In various embodiments, in a case in which the highlight image generation system 1000 does not have the separate electronic device 300, the processor 150 may display the multimedia content on the display unit 120 and extract the biometric characteristic data from the biometric data acquired by the sensor 140. The processor 150 may detect at least one partial content noticed by the user on the basis of the extracted biometric characteristic data. The processor 150 may predict the emotional state of the user associated with the detected at least one partial content and generate the highlight image on the basis of the predicted emotional state.

FIG. 3 is a schematic view for explaining the electronic device according to the embodiment of the present invention.

Referring to FIGS. 1 and 3, the electronic device 300 includes a communication unit 310, a display unit 320, a storage unit 330, and a processor 340.

The communication unit 310 connects the content output device 200 to an external device so that the content output device 200 may communicate with the external device. The communication unit 310 is connected to the HMD device 100 through wired/wireless communication and may transmit and receive various pieces of information. Specifically, the communication unit 310 may transmit the multimedia content to the HMD device 100 and receive the biometric data of the user, acquired by the sensor 140, from the HMD device 100.

The display unit 320 may display various types of contents (e.g., texts, images, videos, icons, banners, or symbols, etc.) to a user. The display unit 320 may display an interface screen for displaying the biometric data of the user received from the HMD device 100. In various embodiments, the display unit 320 may display the multimedia content or the at least one partial content. In various embodiments, the display unit 320 may display the highlight image.

The storage unit 330 may store various data used to generate the highlight image associated with the multimedia content using the biometric data of the user. The storage unit 330 may store the multimedia content to be transmitted to the HMD device 100 and store the biometric data received from the HMD device 100. In various embodiments, the storage unit 330 may store various data used or generated by the operation of the processor 340. In particular, the storage unit 330 may store the at least one partial content and/or the highlight image.

The processor 340 may be operably connected to the communication unit 310, the display unit 320, and the storage unit 330, may transmit the multimedia content to the HMD device 100 through the communication unit 310, and may receive the biometric data of the user, acquired by the sensor 140 of the HMD device 100, while displaying the multimedia content received from the HMD device 100. The processor 340 may extract the biometric characteristic data from the received biometric data and detect the at least one partial content noticed by the user on the basis of the extracted biometric characteristic data. Specifically, the processor 340 may extract the brainwave characteristic data from the brainwave data and/or extract the gaze characteristic data from the gaze data.

The processor 340 may extract the biometric characteristic data on the basis of a deep learning algorithm and/or a classification/regression analysis algorithm, detect the partial content, and determine the emotional state of the user. For example, the processor 340 may extract the brainwave characteristic data and/or the gaze characteristic data on the basis of the deep learning algorithm learned to extract the brainwave characteristic data and/or the gaze characteristic data from the user's brainwave data and/or gaze data acquired by the sensor 140 of the HMD device 100. In this case, the deep learning algorithm may be at least one of DNN, CNN, DCNN, RNN, RBM, DBN, and SSD. However, the deep learning algorithm is not limited to the above-mentioned deep learning algorithms, and the processor 340 may use more various algorithms capable of extracting the biometric characteristic data on the basis of the biometric data received from the HMD device 100.

When the extracted brainwave or gaze characteristic data satisfy the specific condition, the processor 340 may detect the at least one partial content associated with the brainwave or gaze characteristic data, which satisfy the specific condition, as the partial content noticed by the user. In this case, the partial content noticed by the user may include frames corresponding to the scenes noticed by the user, respectively. For example, the specific condition may include a case in which the band power in the specific frequency region of the brainwave or the energy ratio between the alpha wave and the beta wave of the brainwave is greater than or equal to a critical value, a case in which the gaze period or the gaze tracking period is greater than or equal to a critical value, or a case in which the number of eye blinking is lower than or equal to a critical value.

The processor 340 may detect the corresponding partial content on the basis of the deep learning algorithm configured to detect the partial content highly associated with the emotion on the basis of the biometric characteristic data. For example, the processor 340 may determine the partial content having a high degree of notice to the user on the basis of the deep learning algorithm configured to extract the partial content noticed by the user on the basis of the band power in the specific frequency region of the brainwave of the brainwave characteristic data or the energy ratio between the alpha wave and the beta wave of the brainwave. As another example, the processor 340 may determine the partial content having a high degree of notice to the user on the basis of the deep learning algorithm configured to extract the partial data noticed by the user on the basis of the gaze period or the number of eye blinking as the gaze characteristic data. In this case, the deep learning algorithm may be at least one of DNN, CNN, DCNN, RNN, RBM, DBN, and SSD. However, the present invention is not limited thereto, and the processor 340 may use more various algorithms as long as the processor 340 may determine the partial content on the basis of the biometric characteristic data.

The processor 340 may predict the emotional state of the user associated with the detected at least one partial content and generate the highlight image associated with the multimedia content on the basis of the predicted emotional state. Specifically, the processor 340 may use a machine learning technique in order to classify the partial content noticed by the user into the particular number of groups by using the biometric data associated with the at least one partial content noticed by the user. The machine learning technique may include a k-means algorithm, a Gaussian mixture model (GMM), a random forest model, or the like, but the present invention is not limited thereto, and various grouping techniques may be used. In addition, the particular number may be determined by the user or automatically determined by the machine learning algorithm. For example, the processor 340 may cluster the biometric data similar or identical to one another and the at least one partial content corresponding to the biometric data into the same group. When a difference between the biometric data is lower than or equal to a critical value, the processor 340 may determine that the corresponding biometric data are similar or identical to one another.

The processor 340 may extract the emotional state of the user for each of the groups by analyzing the scenes belonging to the at least one partial content corresponding to each of the groups. The processor 340 may finally determine the emotional state of the user on the basis of the classification algorithm configured to classify the emotional state of the user on the basis of the at least one partial content. For example, the classification algorithm may be at least one of random forest, GNB, LNB, and SVM. However, the classification algorithm is not limited to the above-mentioned algorithm, and the processor 340 may use more various algorithms capable of extracting the user's emotion on the basis of the partial content. By using the classification algorithm, the processor 340 may recognize the object, the landscape, the atmosphere, the color, the music, or the like belonging to the scene by analyzing the scenes corresponding to the at least one partial content and predict the emotional state of the user corresponding to at least one of the recognized object, the landscape, the atmosphere, the color, and the music.

In various embodiments, the processor 340 may detect the face from each of the scenes, recognize the expression of the detected face, and predict the emotional state of the user on the basis of the recognized expression. The electronic device 300 may recognize the expression using the artificial neural network algorithm, but the present invention is not limited thereto, and various techniques for recognizing the face may be used. The electronic device 300 may predict the emotional state of the user as “pleasure” when the recognized expression is a smiley expression, and the electronic device 300 may predict the emotional state of the user as “sadness” when the recognized expression is a crying expression. The electronic device 300 may use an inference algorithm in order to predict the emotional state of the user in accordance with the recognized expression, but the present invention is not limited thereto, various techniques may be used to predict the emotional state of the user in accordance with the expression. In various embodiments, the processor 340 may recognize the color and the music from each of the scenes and predict the emotional state of the user in accordance with the recognized color and the recognized music. For example, when the recognized color is a dark color and the recognized music is music in a dark atmosphere, the processor 340 may predict the emotional state of the user as the fear.

In various embodiments, the processor 340 may receive the user's input in respect to the at least one partial content for each of the groups in order to acquire the information on the emotional state of the user in respect to the at least one partial content for each of the groups. For example, the electronic device 300 may provide the interface screen for acquiring the user's input in respect to the at least one partial content for each of the groups through the HMD device 100 and may receive the input in respect to the emotional state of the user who recognizes and feels the at least one partial content for each of the groups through the interface screen. In this case, the interface screen may include the display space for displaying the partial content for each of the groups, and the input space for inputting the emotional state of the user for each of the groups. In various embodiments, in addition to the display space, the interface screen may include the graphic space for tagging each of the groups with the tags associated with the emotional state. For example, in relation to the specific group, when the tag tagged by the user corresponds to “fear”, the processor 340 may determine the emotional state of the user for each specific group as “fear”.

In various embodiments, the processor 340 may provide sample multimedia data for predicting the emotional state of the user through the HMD device 100 before the operation of generating the highlight image, acquire, from the user, the input indicating the emotional state of the user associated with the sample multimedia data, and use the sample multimedia data and the acquired emotional state to determine the emotional state of the user for each of the groups. For example, the processor 340 may provide an interface screen for acquiring the emotional state of the user in respect to any video through the HMD device 100 and acquire information indicating the emotional state of the user for a specific video through the interface screen. The interface screen may include a display space for displaying any video, and an input space for inputting emotion information indicating an emotion that the user feels when watching the corresponding video. When the emotion information indicating the emotional state of the user associated with the specific video is inputted from the user through the interface screen, the processor 340 may map the inputted emotion information and the video and learn the mapped emotion information and the mapped video. Therefore, in order to predict the emotional state of the user for each of the groups to generate the highlight image, the processor 340 may predict the video similar or identical to the learned video as the emotion information mapped to the learned video.

In various embodiments, the processor 340 may receive the user's input for each of the groups in order to correct the emotional state of the user predicted in respect to each of the groups. For example, the processor 340 may provide the interface screen for acquiring, from the user, the emotion information indicating the emotional state of the user for the group in which the emotional state of the user is already predicted through the HMD device 100, and the processor 340 may correct the emotional state of the user for the corresponding group by using the emotion information acquired from the user through the interface screen. The interface screen may include the display space for displaying the at least one partial content belonging to each of the groups, and the input space for inputting the emotion information indicating the emotional state of the user from the corresponding group. When the emotional state predicted in respect to the specific group is “fear” and the emotion information acquired from the user through the interface screen is “disgust”, the processor 340 may correct the emotional state predicted in respect to the specific group from “fear” to “disgust”.

In various embodiments, the processor 340 may receive the user's selection or input for correcting each of the groups, the at least one partial content belonging to each of the groups, the biometric data in respect to the corresponding partial content, and the emotional state predicted in respect to each of the groups. For example, the processor 340 may provide the interface screen for correcting, by the HMD device 100, each of the groups, the at least one partial content belonging to each of the groups, the biometric data in respect to the corresponding partial content, and the emotional state predicted in respect to each of the groups. The interface screen may include various graphic objects (e.g., texts, images, icons, etc.) for modifying (or correcting) the at least one partial content belonging to each of the groups, the biometric data in respect to the partial content, and the emotional state predicted in respect to each of the groups. The graphic object may be configured to be moved or modified by the user. The user may perform various operations through the interface screen, such as an operation of moving the at least one partial content and the biometric data belonging to the specific group to another group, an operation of modifying the emotional state predicted in respect to the specific group, an operation of deleting the at least one partial content or the biometric data belonging to the specific group, or an operation of changing the tag indicating the emotional state from “sadness” to “despair”. Therefore, the present invention may accurately check the emotional state of the user in respect to the at least one partial content corresponding to each of the groups in accordance with the user's input or selection.

When the operation of predicting or determining the emotional state of the user for each of the groups is completed, the processor 340 may generate the highlight image using the at least one partial content belonging to each of the groups. Specifically, the processor 300 may arrange the at least one partial content for each of the groups in an arrangement order and generate the highlight image including the arranged at least one partial content. In this case, the arrangement order includes the temporal order, the increasing order of the emotional state of the user, the decreasing or increasing order of the user's notice and/or concentration, or the order in which the user feels funny or not, but the present invention is not limited thereto, and various orders may be included. On the basis of the biometric characteristic data, the processor 340 may determine the increasing order of the emotional state of the user, the decreasing or increasing order of the user's notice and/or concentration, or the order in which the user feels funny or not. For example, the processor 340 may determine the order in which a peak value of the energy ratio between the alpha wave and the beta wave of the brainwave becomes from a small value to a large value as the decreasing order of the emotional state. When a peak value of the band power in the specific frequency region of the brainwave is large, the processor 340 may determine that the degree of the user's notice and/or concentration is high or the user feels funny, but the present invention is not limited thereto, and various methods may be used.

Hereinafter, the embodiment in which the partial content is arranged in the arrangement order will be described, when the at least one partial content detected from video data such as movies is grouped into four groups, the emotional state in respect to the at least one partial content corresponding to a first group is “joy”, the emotional state in respect to the at least one partial content corresponding to a second group is “sadness”, the emotional state in respect to the at least one partial content corresponding to a third group is “fear”, the emotional state in respect to the at least one partial content corresponding to a fourth group is “relief”, and the temporal order is the order of the first group to the fourth group. In this case, the processor 340 may arrange the at least one partial content in the order of the first group, the second group, the third group, and the fourth group in the temporal order. In various embodiments, when the emotional state of the user is raised in the order of “sadness”, “fear”, “relief”, and “joy”, the processor 340 may arrange the at least one partial content in the order of the second group, the third group, the fourth group, and the first group. In various embodiments, the degree of the user's notice and/or concentration increases in the order of the fourth group, the first group, the second group, and the third group, the processor 340 may arrange the at least one partial content in the order of the fourth group, the first group, the second group, and the third group. In various embodiments, the processor 340 may also arrange the at least one partial content in the order of the partial content including the user's object of interest. For example, the processor 340 may analyze the user's gaze and brainwave data and recognize an object, on which the user's gaze is positioned the particular number of times or for a particular period of time in the at least one partial content, as the object of interest, and the processor 340 may arrange the at least one partial content in the order of the partial content including the recognized object. In various embodiments, the processor 340 may also arrange the at least one partial content including the user's object of interest in increasing order of the emotional state of the user. For example, the processor 340 may arrange the at least one partial content in the increasing order of the emotional state of the user by extracting the at least one partial content, which is included in the user's object of interest among the at least one partial content belonging to each of the groups, and checking the biometric data of the user associated with the extracted at least one partial content.

The processor 340 may generate the highlight image including the at least one partial content arranged as described above. For example, the processor 340 may generate the highlight image by combining the at least one partial content, editing the at least one partial content, or applying an effect to the at least one partial content.

Therefore, the present invention may generate and provide the user-customized highlight image in accordance with the emotional state of the user and provide the highlight image focusing the object noticed by the user, thereby increasing the user's satisfaction.

In various embodiments, before the operation of generating the highlight image, the processor 340 may set reference biometric characteristic data (e.g., reference brainwave characteristic data and/or reference gaze characteristic data) in order to detect the at least one partial content noticed by the user. For example, the processor 340 may provide the HMD device 100 with the multimedia image data for acquiring brainwave data corresponding to a comfortable state of the user and receive brainwave data acquired from the HMD device 100 while the user watches the multimedia image data. For example, the processor 340 may provide the HMD device 100 with multimedia image data in which a white cross is positioned on a screen with a black background and a guide text for allowing the user to gaze at the white cross is included. In various embodiments, the processor 340 may further provide the HMD device 100 with audio data corresponding to calm music that allows the user to feel comfortable. When the processor 340 receives, from the HMD device 100, the user's brainwave data acquired by the sensor 140 while the user gazes at the white cross, the processor 340 may extract the brainwave characteristic data from the acquired brainwave data and set the extracted brainwave characteristic data as the reference brainwave characteristic data. The processor 340 may detect the at least one partial content concentrated and/or noticed by the user using the reference brainwave characteristic data set as described above. The processor 340 compares the extracted brainwave characteristic data and the reference brainwave characteristic data, and when a difference between the two data is critical value or more, the processor 340 may determine the at least one partial content associated with the acquired brainwave data as the partial content noticed by the user.

In various embodiments, when the processor 340 receives, from the HMD device 100, the user's gaze data acquired by the sensor 140 while the user gazes at the white cross, the processor 340 may extract the gaze characteristic data from the acquired gaze data and set the extracted gaze characteristic data as the reference gaze characteristic data. The processor 340 may detect the at least one partial content concentrated and/or noticed by the user using the reference gaze characteristic data set as described above. The processor 340 compares the extracted gaze characteristic data and the reference gaze characteristic data, and when a difference between the two data is critical value or more, the processor 340 may determine the at least one partial content associated with the acquired gaze data as the partial content noticed by the user.

In various embodiments, in order to predict a position at which the user gazes, the processor 340 may learn the gaze data acquired from the HMD device 100 while the user gazes at a particular position. For example, the processor 340 may provide the HMD device 100 with the multimedia image data for acquiring gaze data indicating the user's gaze motion and receive gaze data acquired from the HMD device 100 while the user watches the multimedia image data. For example, the processor 340 may provide the HMD device 100 with the multimedia image data in which white points flicker at various positions on a screen with a black background.

When the processor 340 receives, from the HMD device 100, the user's gaze data acquired by the sensor 140 while the user gazes at various positions at which the white points flicker, the processor 340 may learn the acquired gaze data and predict the position at which the user gazes by using the gaze data received from the HMD device 100 after the learning.

The operation of setting the reference biometric data may be selectively performed. For example, in a case in which the processor 340 detects the partial content noticed by the user by means of the learning, the operation of setting the reference biometric data may not be performed.

The interface screen and the space and the graphic object included in the interface screen are not limited to the above-mentioned contents, and various methods may be used to acquire the specific data.

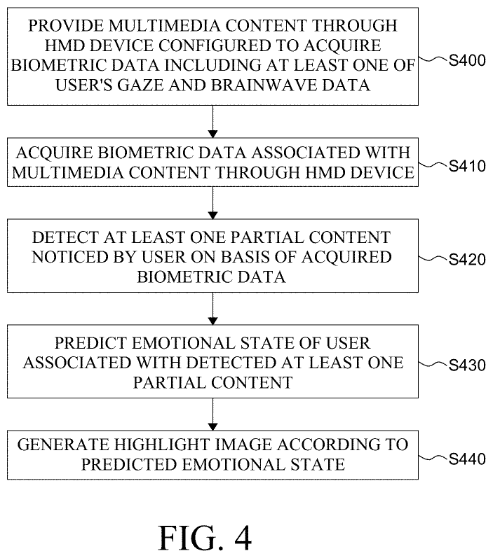

FIG. 4 is a schematic flowchart for explaining a method of generating a highlight image associated with multimedia content on the basis of biometric data of a user by the electronic device according to the embodiment of the present invention. Hereinafter, the configuration in which the HMD device 100 and the electronic device 300 are separately operated will be described for convenience, but the present invention is not limited thereto, and all the operations illustrated in FIG. 4 may also be performed by the single HMD device 100 or the content output device 200 that may be connected to the HMD device 100.

Referring to FIGS. 1 and 4, the electronic device 300 provides the multimedia content through the HMD device 100 configured to acquire the biometric data including at least one of the user's brainwave and gaze data (S400). The electronic device 300 may acquire the biometric data associated with the multimedia content through the HMD device 100 (S410). The electronic device 300 detects the at least one partial content noticed by the user on the basis of the acquired biometric data (S420). Specifically, the electronic device 300 may extract the biometric characteristic data from the acquired biometric data and detect the at least one partial content noticed by the user on the basis of the extracted biometric characteristic data. The electronic device 300 predicts the emotional state of the user associated with the detected at least one partial content (S430) and generates the highlight image on the basis of the predicted emotional state (S440). Specifically, the electronic device 300 may group the detected at least one partial content and the biometric data associated with the at least one partial content into one or more groups and predict the emotional state of the user for each of the groups by analyzing the scenes of the at least one partial content for each of the groups. The electronic device 300 may generate the highlight image using the at least one partial content each of the groups corresponding to the predicted emotional state.

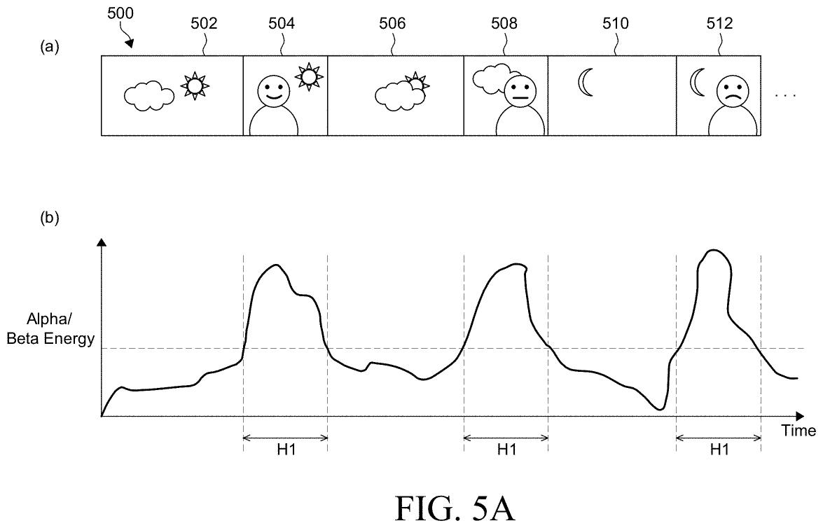

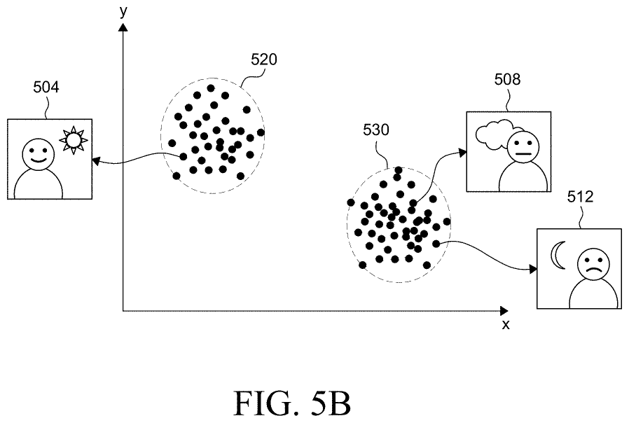

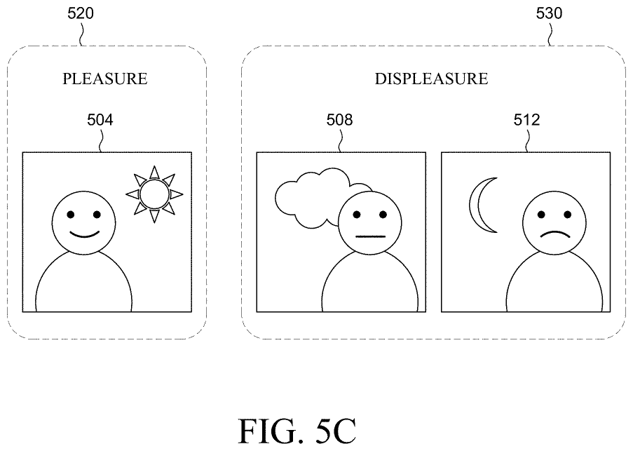

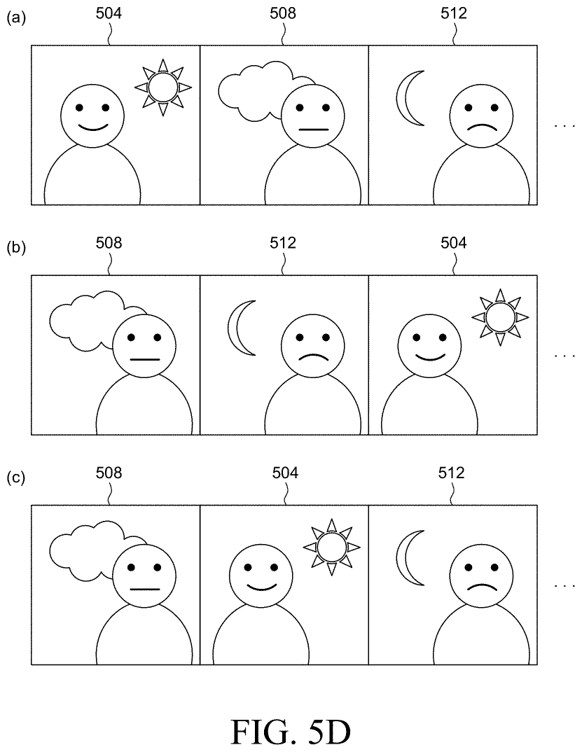

FIGS. 5A, 5B, 5C, and 5D are exemplified views for explaining methods of generating highlight images associated with multimedia content on the basis of biometric data of the user by the electronic device according to the embodiment of the present invention. In the provided embodiment, a method of generating a highlight image in respect to multimedia content corresponding to movies based on biometric data of a user will be described.

Referring to FIGS. 1 and 5A, the electronic device 300 may provide multimedia content 500 illustrated in FIG. 5A (a) through the HMD device 100. While the multimedia content 500 is displayed through the HMD device 100, the electronic device 300 may acquire the biometric data of the user from the HMD device 100 and extract the biometric characteristic data from the acquired biometric data. For example, in the case in which the biometric data are the brainwave data, the brainwave characteristic data extracted from the brainwave data may be represented in a graph showing the energy ratio between the alpha wave and the beta wave of the brainwave over time as illustrated in FIG. 5A (b). In this case, the period may be a replay period of the multimedia content 500. The electronic device 300 may detect the at least one partial content in which the energy ratio between the alpha wave and the beta wave of the brainwave is a critical value (a) or more in the multimedia content. The at least one partial content, in which the energy ratio is the critical value (a) or more, may include a first partial content 502 corresponding to a replay period H1, a second partial content 504 corresponding to a replay period H2, and a third partial content 506 corresponding to a replay period H3. The electronic device 300 may group the detected at least one partial content and the brainwave data associated with the partial content into one or more groups. For example, the electronic device 300 may use the k-means algorithm and group at least one partial content and the brainwave data associated with the partial content, which are similar or identical to one another, into one or more groups. The at least one partial content and the brainwave data associated with the partial content, which are grouped as described above, may be represented in a graph as illustrated in FIG. 5B.

Referring to FIG. 5B, the at least one partial content and the brainwave data associated with the partial content may be grouped into two groups including a first group 510 and a second group 520. In a case in which the first partial content 502 is included in the first group 510 and the second partial content 504 and the third partial content 506 are included in the second group 520, it may be seen that the first partial content 502 is different in feature from the second partial content 504 and the third partial content 506 and the second partial content 504 is similar or identical in feature to the third partial content 506.

The electronic device 300 may predict the emotional state of the user for each of the groups by analyzing the scenes of the first partial content 502, the second partial content 504, and the third partial content 506 which belong to the two groups, respectively. Specifically, the electronic device 300 may predict the emotional state of the user for the first group including the first partial content 502 and the emotional state of the user for the second group including the second partial content 504 and the third partial content 506 by analyzing the object, the landscape, the atmosphere, the color, the music or the like included in each of the scenes of the first partial content 502, the second partial content 504, and the third partial content 506 by using the machine learning technique (e.g., the deep learning and/or the classification algorithm, etc.). For example, the electronic device 300 may detect the face from each of the scenes of the first partial content 502, the second partial content 504, and the third partial content 506, recognize the expression of the detected face, and predict the emotional state of the user in accordance with the predicted expression. For example, the expression recognized in respect to the first partial content 502 is a smiley expression, the electronic device 300 may predict the emotional state of the user for the first group 510 as “pleasure”. In a case in which the expression recognized in respect to the second partial content 504 is a blank expression and the expression recognized in respect to the third partial content 506 is a sad expression, the electronic device 300 may predict the emotional state of the user for the second group 520 as “displeasure”. As illustrated in FIG. 5C, the electronic device 300 may map the first group 510 and the emotional state (pleasure) predicted in respect to the first group 510 and map the second group 520 and the emotional state (displeasure) predicted in respect to the second group 520.

The electronic device 300 may generate the highlight image using the at least one partial content belonging to the first group 510 and the second group 520, respectively, in which the emotional states are predicted as described above. Specifically, the electronic device 300 may arrange the at least one partial content in the arrangement order and generate the highlight image including the arranged at least one partial content. For example, in a case in which the replay time order is the order of the first, second, and third partial contents, the electronic device 300 may arrange the first, second, and third partial contents 502, 504, and 506 in the replay time order and generate the highlight image including the arranged first, second, and third partial contents 502, 504, and 506, as illustrated in FIG. 5D (a). In various embodiments, in a case in which the decreasing order of the user's emotion is the order of the second, third, and first partial contents, the electronic device 300 may arrange the second, third, and first partial contents 504, 506, and 502 in the decreasing order of the user's emotion and generate the highlight image including the arranged second, third, and first partial contents 504, 506, and 502, as illustrated in FIG. 5D (b). In various embodiments, in a case in which the decreasing order of the degree of the user's notice and/or concentration is the order of the second, first, and third partial contents, the electronic device 300 may arrange the second, first, and third partial contents 504, 502, and 506 in decreasing order of the degree of the user's notice and/or concentration and generate the highlight image including the arranged second, first, and third partial contents 504, 502, and 506, as illustrated in FIG. 5D (c). The generated highlight image may be replayed by the HMD device 100, the content output device 200, or the electronic device 300.

In various embodiments, the electronic device 300 may generate the highlight image by combining and/or editing the at least one partial content, but the present invention is not limited thereto, and various effects may be applied to any one or more partial content in the at least one partial content. The various effects include, but not limited to, texts, icons, image inputs, compositing, overlay, light burst, color inversion, black-white conversion, specific color emphasizing, and the like.

As described above, the present invention may provide the user-customized highlight image by generating the highlight image associated with the multimedia content using the biometric data of the user acquired while the user watches or experiences the multimedia content.

In addition, the present invention may provide the highlight image focusing on the object noticed by the user, thereby improving the user's satisfaction.

The apparatus and the method according to the exemplary embodiment of the present invention may be implemented in the form of program instructions executable by means of various computer means and then written in a computer-readable recording medium. The computer-readable medium may include program instructions, data files, data structures, or the like, in a stand-alone form or in a combination thereof.

The program instructions written in the computer-readable medium may be designed and configured specifically for the present invention or may be publicly known and available to those skilled in the field of computer software. Examples of the computer-readable recording medium may include magnetic media, such as a hard disk, a floppy disk and a magnetic tape, optical media, such as CD-ROM and DVD, magneto-optical media, such as a floptical disk, and hardware devices, such as ROM, RAM, and flash memory, which are specifically configured to store and run program instructions. In addition, the above-mentioned media may be transmission media such as optical or metal wires and waveguides including carrier waves for transmitting signals for designating program instructions, data structures, and the like. Examples of the program instructions may include machine codes made by, for example, a compiler, as well as high-language codes that may be executed by an electronic data processing device, for example, a computer, by using an interpreter.

The above-mentioned hardware devices may be configured to operate as one or more software modules in order to perform the operation of the present invention, and the opposite is also possible.

Although the embodiments of the present invention have been described in detail with reference to the accompanying drawings, the present invention is not limited thereto and may be embodied in many different forms without departing from the technical concept of the present invention. Therefore, the exemplary embodiments of the present invention are provided for illustrative purposes only but not intended to limit the technical concept of the present invention. The scope of the technical concept of the present invention is not limited thereto. Therefore, it should be understood that the above-described exemplary embodiments are illustrative in all aspects and do not limit the present invention. The protective scope of the present invention should be construed based on the following claims, and all the technical spirit in the equivalent scope thereto should be construed as falling within the scope of the present invention.

### DESCRIPTION OF REFERENCE NUMERALS

100: HMD device

200: Content output device

300: Electronic device

1000: Highlight image generation system

What is claimed is:

1. A method of generating a highlight image using biometric data of a user executed by a processor of a device for generating a highlight image, the method comprising:
providing multimedia content through a head-mounted display (HMD) device configured to acquire biometric data comprising at least one of a user's brainwave data and gaze data;
acquiring biometric data associated with the multimedia content through the HMD device;
detecting at least one partial content noticed by the user on the basis of the acquired biometric data;
predicting an emotional state of the user associated with the detected at least one partial content; and
generating a highlight image according to the predicted emotional state.

2. The method of claim 1, wherein the detecting of the partial data noticed by the user on the basis of the acquired biometric data includes:
extracting biometric characteristic information from the acquired biometric data; and
detecting the at least one partial content on the basis of the extracted biometric characteristic data.

3. The method of claim 2, wherein the biometric characteristic data comprises at least one of gaze characteristic data extracted from the gaze data and brainwave characteristic data extracted from the brainwave data,
wherein the gaze characteristic data comprises a gaze period for which the user gazes, a gaze tracking period for which the user's gaze tracks a specific object of the multimedia content, or the number of eye blinking the user's eye blinks, and
wherein the brainwave characteristic data comprises band power in a specific frequency region of a brainwave or an energy ratio between an alpha wave and a beta wave of the brainwave.

4. The method of claim 3, wherein the detecting of the at least one partial content on the basis of the extracted biometric characteristic data is:
detecting the at least one partial content associated with the band power or the energy ratio when the band power in the specific frequency region of the brainwave is greater than or equal to a critical value, or the energy ratio between the alpha wave and the beta wave of the brainwave is greater than or equal to a critical value.

5. The method of claim 3, wherein the detecting of the at least one partial content on the basis of the extracted biometric characteristic data is:
detecting at least one partial content associated with the gaze period or the gaze tracking period when the gaze period or the gaze tracking period is greater than or equal to a critical value,
or detecting at least one partial content associated with the number of eye blinking when the number of eye blinking is lower than or equal to a critical value.

6. The method of claim 1, wherein the predicting of the emotional state of the user using the detected at least one partial content comprises:
grouping the detected at least one partial content and the biometric data associated with the at least one partial content into one or more groups;
predicting an emotional state corresponding to the one or more groups; and
mapping the predicted emotional state and the one or more groups.

7. The method of claim 6, wherein the predicting of the emotional state corresponding to the one or more groups is
predicting the emotional state of the user for the one or more groups by analyzing scenes of the at least one partial content belonging to the one or more groups.

8. The method of claim 6, wherein the generating of the highlight image according to the predicted emotional state comprises:
arranging the at least one partial content belonging to the one or more groups in a predetermined arrangement order; and
generating a highlight image comprising the arranged at least one partial content.

9. The method of claim 8, wherein the arrangement order comprises at least one of a temporal order, an increasing order of the emotional state of the user, and a decreasing order of a degree of the user's notice and/or concentration.

10. A device for generating a highlight image using biometric data, the device comprising:
a communication unit;
a storage unit; and
a processor operably connected to the communication unit and the storage unit,
wherein the processor is configured to
provide multimedia content through a head-mounted display (HMD) device configured to acquire biometric data comprising at least one of a user's brainwave and gaze data,
acquire biometric data associated with the multimedia content through the HMD device,
detect at least one partial content noticed by the user on the basis of the acquired biometric data,
predict an emotional state of the user associated with the detected at least one partial content, and
generate a highlight image according to the predicted emotional state.

11. The device of claim 10, wherein the processor is further configured to extract biometric characteristic information from the acquired biometric data and detect the at least one partial content on the basis of the extracted biometric characteristic data.

12. The device of claim 10, wherein the processor is further configured to group the detected at least one partial content and a biometric data associated with the at least one partial content into one or more groups, predict an emotional state corresponding to the one or more groups, and map the predicted emotional state and the one or more groups.

13. The device of claim 12, wherein the processor is further configured to predict the emotional state of the user for the one or more groups by analyzing scenes of the at least one partial content belonging to the one or more groups.

14. The device of claim 12, wherein the processor is further configured to arrange the at least one partial content belonging to the one or more groups in a predetermined arrangement order and generates a highlight image comprising the arranged at least one partial content.

15. The device of claim 10, wherein the multimedia content comprises a non-interactive image and an interactive image that interacts with the user.
